(19) United States
(12) Patent Application Publication
(10) Pub. No.: US 2007/0033557 A1
(43) Pub. Date: Feb. 8, 2007

(54) Method for creating constraints for integrated circuit design closure

(76) Inventors: Jonathan W. Byrn, Kasson, MN (US); Matthew Wingren, Rochester, MN (US); Paul Reuland, Rochester, MN (US)

Correspondence Address: LSI LOGIC CORPORATION, 1621 BARBER LANE, MS: D-106, MILPITAS, CA, 95035, US

(21) Appl. No.: 11/199,434

(22) Filed: Aug. 8, 2005

(51) Int. Cl. G06F 17/50

(52) U.S. Cl. 716/5; 716/6

(57) ABSTRACT

A method for creating constraints for integrated circuit design closure is provided. Design specifications are captured before a design flow is started. The design specifications are checked for compatibility with the design flow. The design specifications are stored in a database. Output transforms are applied to the design specifications to create orthogonal constraint sets which are tuned for both a specific tool and a positional use of the specific tool within the design flow.

### FIELD OF THE INVENTION

The present invention generally relates to the field of integrated circuits, particularly to a method for creating constraints for integrated circuit design closure.

### BACKGROUND OF THE INVENTION

Creating constraints for integrated circuit design closure that are suitable to all of the tools used to develop and verify an integrated circuit design is a difficult, significantly manual, confusing and error prone task. Constraints are all of the files and directives that are used to guide or drive the design tools. This includes, but is not limited to, Synopsys Design Constraints (SDC), synthesis directives, physical optimization directives, and the like. Tool-specific combinations of each of these kinds of files or directives are used to guide specific tools. However, in a typical design flow there are varying levels of these files supported by each tool and different interpretations of the same directives.

Conventionally, the problem of creating constraints is solved with an ad hoc approach of constraints generation and integration flow. This approach typically involves manually generated specific constraints, tool generated constraints, and constraints that need be customized on an instance basis (e.g., 3rd party IP constraints). This collection of constraints is typically used as a starting point to create constraints that are adjusted manually and/or programmatically by translation based on the needs of the tools and the needs of the design flow.

However, the conventional approach has many disadvantages. First, it is very manually intensive and prone to integration error with manual customization. In addition, translating constraints may result in a loss of information. Moreover, no single tool covers all of the combinations of constraints. Further, different steps in the flow, even using the same tools, often require a unique constraint package. Additionally, tool errors may create the need for temporary constraint modifications. To make things worse, these issues may then combine with a typically serial propagation of constraints from the first tool through the last tool. Moreover, at some stages unique branches need be created, which may generate multiple concurrent maintenance paths. Further, if possible, the flow may require the insertion and removal of constraints, either manually or programmatically, which are specific to one stage versus a previous stage as the constraints propagate. In addition, it is often the case that key constraint-related data is not captured early in the development cycle and need be added via interaction with the originators of the design and the final processors of the design. This is an error prone, iterative and time consuming process, which may reveal, very late in design closure, errors that may trigger a complete restart of the optimization process. This restart may invalidate a significant amount of the logical validation of the design. With all of these issues, the system may become inherently more unstable: the further the constraints proceed through the development flow, the more manual steps are involved.

Thus, it is desirable to provide a method which may address the foregoing described problems.

### SUMMARY OF THE INVENTION

In an exemplary aspect, the present invention provides a method for creating constraints for integrated circuit design closure. Design specifications are captured before a design flow is started. The design specifications are checked for compatibility with the design flow. The design specifications are stored in a database. Output transforms are applied to the design specifications to create orthogonal constraint sets which are tuned for both a specific tool and a positional use of the specific tool within the design flow.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flowchart of a method for creating constraints for integrated circuit design closure in accordance with an exemplary embodiment of the present invention, where the method includes a step of generating tool and flow specific constraints; and

FIG. 2 is a flowchart illustrating the step of generating tool and flow specific constraints shown in FIG. 1 in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

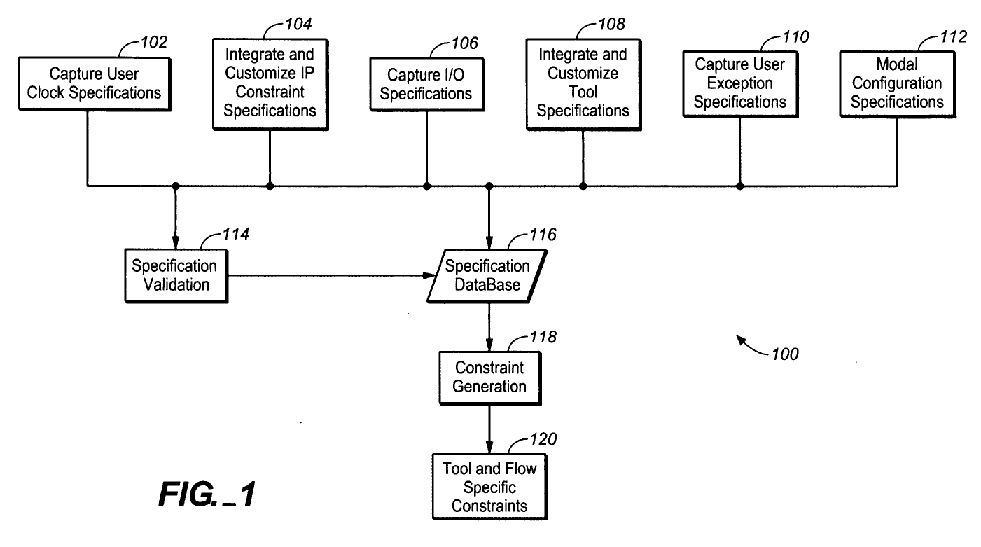

Referring now to FIG. 1, a flowchart of a method 100 for creating constraints for integrated circuit design closure is shown. Design specifications may be captured 102 through 112. Preferably, the design specifications are captured up front, i.e., at the beginning stages of the design flow, or at the beginning stages of a step in the flow if the specifications are desired to be captured later. An example of the later step is a flow where mfg test is inserted in the middle of the flow. In this case one may desire to insert the additional specifications at the beginning of that step. While it is not as good as all up front, it is as up front as possible. The design specifications are augmented as needed by the design flow. The design specifications may include user clock specifications 102, Intellectual Property (IP) specifications 104, I/O specifications 106, tool specifications 108, user exception specifications 110, and/or modal configuration specifications 112.

The clock specifications 102 identify the clocks or clock like functions and the required characteristics associated with them. For example, a clock typically has characteristics such as frequency, duty cycle and uncertainty as some base characteristics. The clock specification often also includes characteristics that describe their relationships to other clocks. For example, a clock may need to have a coincident edge with one or more clocks, or it may have a start up logical relationship with those clocks (e.g., when three clocks that have been related by an edge need to all become active coming out of reset on the same edge). The IP specifications 104 are a localized set of the same kinds of specifications that are in the reset of the design.

The I/O specifications 106 describe the characteristics associated with the I/O. These may include specifications indicating when a signal propagating to/from an I/O needs to be valid. They may further specify the valid time to rising or valid time to falling. They often include characteristics that describe their relationships to other I/O or to clocks. For example, a set of I/O may need to propagate their signal such that all of the valid values across them occur within a window of time. I/O's may also have a relationship with a clock in that their valid propagation time is relative to a specific clock.

The tool specifications 108 are the expression of the capabilities and requirements of the design flow and the tools within it in the context of the overall goals of the system. The tools in the flow may require custom files that are not part of a recognized standard. For example, a tool may require a file that explicitly describes a relationship between two clocks. Another example may be supplying a set of rules specifications that bound what the design system may accomplish using that tool. The tool may not be able to effectively optimize specific design scenarios (e.g., the tool may not effectively deliver a specific edge relationship between clocks. These restrictions may feed into specification validation).

The exception specifications 110 are specific requirements within a design that are explicitly captured directly with I/O or clock specifications. An example of this is a case where a register in a design is used exclusively as a set up register. This means that the timing paths that emanate from this register may have relaxed requirements. Another case is when specific paths within the design may never be exercised, where checking of the timing on these paths may be disabled.

The modal configuration specifications 112 control the functional configuration of a design. For example, the design may have multiple functional capabilities overlaid on a common single set of hardware. Each of these functional configurations results in a set of functional modes. These specifications govern how these modes are activated. For example, a clock in the design may have a mux that controls its clock source. In one mode one branch of the mux is the clock source, and in another mode the other branch of the mux is the clock source. Thus, the pin that controls the mux is the mode control. Another example is where a programmable divider is used to create a clock. Thus, the pins that control the size of the division are the mode controls. The modal specification is the state information associated with all of the internal and external mode controls. =p The design specifications are checked for compatibility with the design flow 114. The design specifications are stored in a database or other data storage format 116. The specifications that are stored in the database may then be transformed using a script and/or program, or a set of scripts/programs. This body of code is applied to the design specifications to create orthogonal constraint sets 118 which are tuned for both a specific tool and a positional use of the specific tool within the design flow (i.e., tool and flow specific constraints) 120.

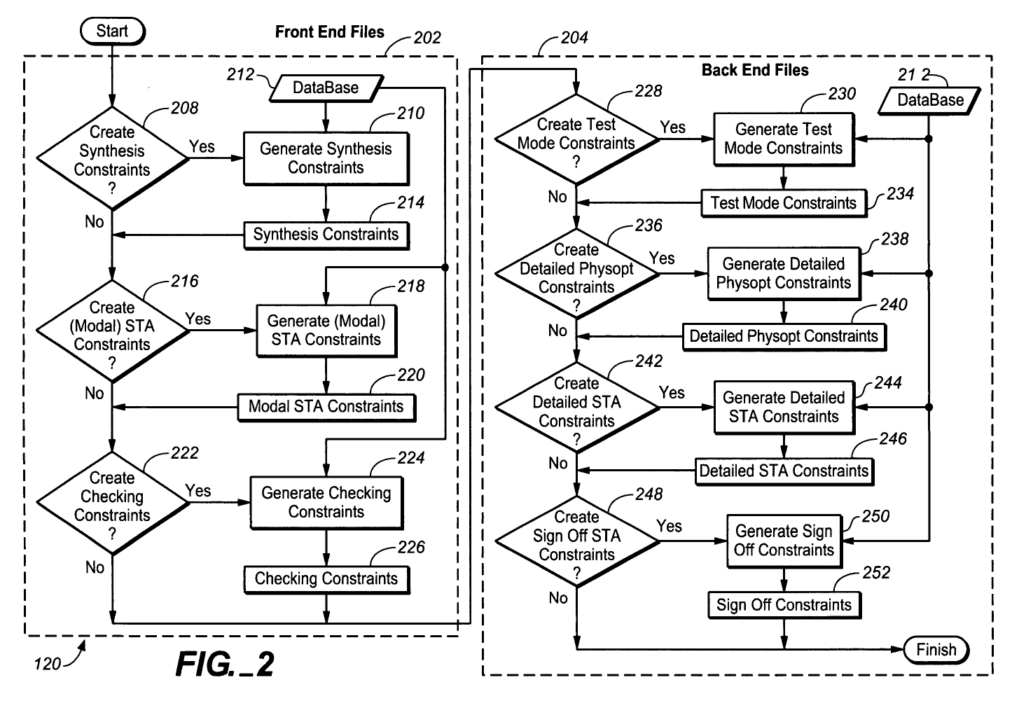

FIG. 2 is a flowchart illustrating the step of generating tool and flow specific constraints 120 shown in FIG. 1 in accordance with an exemplary embodiment of the present invention. As shown, the step of generating tool and flow specific constraints 120 may generate front end files 202 and back end files 204. In the front end of a design flow, it is checked whether synthesis constraints are desired to be created 208. Synthesis constraints are used to drive the synthesis tool(s) within the design flow. In some cases, synthesis may be logical synthesis. In other cases, synthesis may be physical synthesis. In both cases, synthesis represents the transformation of a high level circuit specification into a typically though non-exclusively technology-dependent specification. It may typically takes into account key characteristics from the specification that may drive this process. Typical synthesis constraints include those that specify the definitions of all the clocks in the system, all the I/O timings and all of the circuit paths that may take more than a single cycle. Physical synthesis may include most of the elements of logical synthesis and add physical constraints such as placement directives that specify where specific circuits need to reside on the chip. These may include I/O locations, IP locations, etc. Some of the constraints in logical synthesis may not be present in physical synthesis because they are place holder estimates for not having the physical design data. Therefore, they may not be generated. These constraints may likely be a mix of standardized and tool specific constraints.

If the answer is yes, synthesis constraints are generated 210 based on the specification database 212 obtained in the step 116 shown in FIG. 1, and independent synthesis constraints 214 are obtained; if the answer is no, it is checked whether Modal STA constraints are desired to be created 216. Modal constraints are used for modal Static Timing Analysis (STA). Typical Modal constraints include those that specify the definitions of all the clocks in the system, all the I/O timings, and all of the circuit paths that may take more than a single cycle. However, they may represent each of these values relative to the functional operational definitions of the chip. If the answer is yes, Modal STA constraints are generated 218 based on the specification database 212, and independent Modal STA constraints 220 are obtained; if the answer is no, it is checked whether checking constraints are desired to be created 222. Checking constraints are used to help facilitate netlist or RTL level checking. These constraints may be modal in nature if modal analysis is used. For example, they may include constraints that define all of the clocks in a way the checking tool(s) may comprehend. In addition, for the basic specifications of frequency, duty cycle and uncertainty, high level of constraints (e.g., for clock relationships) are desired to facilitate cross clock domain circuit checking. If the answer is yes, checking constraints are generated 224 based on the specification database 212, and independent checking constraints 224 are obtained; if the answer is no, the step 120 proceeds to the back end of the design flow, where it is checked whether test mode constraints are desired to be created 228. Test mode constraints may contain the definitions of all the clocks in test mode (frequency, duty cycle, uncertainty) as well as the constraints that specify the circuit configurations that govern putting the design into that mode. Test mode constraints may also include I/O constraints for Test mode as well. If the answer is yes, test mode constraints are generated 230 based on the specification database 212, and independent test mode constraints 234 are obtained; if the answer is no, it is checked whether detailed physical optimization constraints are desired to be created 236. Detailed physical optimization constraints may include many of the constraints from physical synthesis. Typical detailed physical optimization constraints include those that specify the definitions of all the clocks in the system, all the I/O timings, and all of the circuit paths that can take more than a single cycle. However, additional non-standard format constraints may be required. For example, if the actual clock tree has not yet been inserted, it may need to be inserted. To implement this insertion, the target characteristics of the tree need to be specified to the tool which may synthesize the clock tree. Some of these characteristics may include zero skew clock definitions, and clocks that have specific edge relationships that must be maintained between them. An addition common constraint is the definition of the structure and composition of the clock tree. For example, a specific set of clock buffers and/or inverters may be used to build the tree. In the case of I/O constraints, those are augmented with based on additional information such as knowledge of the depths of various clock trees. If the answer is yes, detailed physical optimization constraints are generated 238 based on the specification database 212, and independent detailed physical optimization constraints 240 are obtained; if the answer is no, it is checked whether detailed STA constraints are desired to be created 242. Detailed STA constraints are typically multi-modal, may utilize the availability of different information within the system, and may cover multiple functional modes. These constraints include the foregoing described clock, I/O and exception constraints. They may also include special scripts/programs that may collect additional information from the timing reports (e.g., scripts/programs that determine if a low skew interface is in fact low skew). If the answer is yes, detailed STA constraints are generated 244 based on the specification database 212, and independent detailed STA constraints 246 are obtained; if the answer is no, it is checked whether sign off STA constraints are desired to be created 248. STA sign off constraints represent the inclusion of all of the foregoing described clock, I/O and exception constraints. They may also include special scripts/programs that may collect additional information from the timing reports that act as meta constraints (e.g., scripts/programs that determine if a low skew interface is in fact low skew). If the answer is yes, sign off STA constraints are generated 250 based on the specification database 212, independent sign off STA constraints 250 are obtained, and the step 120 ends; if the answer is no, the step 120 ends.

Although FIG. 2 shows some representative constraint targets and their now independent generation, those of ordinary skill in the art will understand that the step 120 shown in FIG. 2 may include other constraint targets and their generation without departing from the scope and spirit of the present invention.

Thus, in accordance with the present invention, design specifications may be utilized in the source constraint generation, constraints may be independently created for each tool in the design flow in the context of the flow step, constraint generation may span the entire end to end (front end to back end) flow, and specification checking may be utilized to check for design system compliance, which may facilitate the identification and handling of exceptions.

The present invention may provide the following advantages in the management and creation of constraints. First, the present invention may directly create the tool correct and flow step appropriate constraints without serial translation, sequential insertion/removal, multiple maintenance threads, the loss of information due to different constraint support and interpretation on a tool by tool basis, or manual/programmatic custom modification to correct for serial translation error. In addition, the present invention may remove the late cycle iteration and risk associated with the late collection and may use key design specifications. Moreover, the present invention may induce great stability since changes in the local tool and flow specific constraints may not propagate to the other tool and flow stages. Further, up front specification checking may provide for additional certainty, where if all the specification requirements are met the entire flow may run smoothly. Where full compliance is not possible, the exceptions may be captured to enable effective up front handling.

It is to be noted that the foregoing described embodiments according to the present invention may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the present invention may be conveniently implemented in forms of a software package. Such a software package may be a computer program product which employs a computer-readable storage medium including stored computer code which is used to program a computer to perform the disclosed function and process of the present invention. The computer-readable medium may include, but is not limited to, any type of conventional floppy disk, optical disk, CD-ROM, magneto-optical disk, ROM, RAM, EPROM, EEPROM, magnetic or optical card, or any other suitable media for storing electronic instructions.

It is understood that the specific order or hierarchy of steps in the processes disclosed is an example of exemplary approaches. Based upon design preferences, it is understood that the specific order or hierarchy of steps in the processes may be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for creating constraints for integrated circuit design closure, comprising steps of:
capturing design specifications;
checking said design specifications for compatibility with a design flow;
storing said design specifications; and
applying output transforms to said design specifications to create orthogonal constraint sets that are tuned for both a specific tool and a positional use of said specific tool within said design flow.

2. The method of claim 1, wherein said design specifications are captured before said design flow is started.

3. The method of claim 1, wherein said design specifications include at least one of user clock specifications, IP constraint specifications, I/O specifications, tool specifications, user exception specifications, or modal configuration specifications.

4. The method of claim 1, wherein said design specifications are stored in a database.

5. The method of claim 1, wherein said orthogonal constraint sets are independently created for each tool in said design flow in a context of flow steps.

6. The method of claim 1, wherein said orthogonal constraint sets are created throughout said design flow, said design flow being an end to end flow.

7. The method of claim 1, wherein said applying step comprises generating synthesis constraints when said synthesis constraints are desired to be created.

8. The method of claim 7, wherein said applying step further comprises generating modal STA constraints when said modal STA constraints are desired to be created.

9. The method of claim 8, wherein said applying step further comprises generating checking constraints when said checking constraints are desired to be created.

10. The method of claim 9, wherein said applying step further comprises generating test mode constraints when said test mode constraints are desired to be created.

11. The method of claim 10, wherein said applying step further comprises generating detailed physical optimization constraints when said detailed physical optimization constraints are desired to be created.

12. The method of claim 11, wherein said applying step further comprises generating detailed STA constraints when said detailed STA constraints are desired to be created.

13. The method of claim 12, wherein said applying step further comprises generating sign off STA constraints when said sign off STA constraints are desired to be created.

14. A computer-readable medium having computer-executable instructions for performing a method for creating constraints for integrated circuit design closure, said method comprising steps of:
capturing design specifications;
checking said design specifications for compatibility with a design flow;
storing said design specifications; and
applying output transforms to said design specifications to create orthogonal constraint sets that are tuned for both a specific tool and a positional use of said specific tool within said design flow.

15. The computer-readable medium of claim 14, wherein said design specifications are captured before said design flow is started.

16. The computer-readable medium of claim 14, wherein said design specifications include at least one of user clock specifications, IP constraint specifications, I/O specifications, tool specifications, user exception specifications, or modal configuration specifications.

17. The computer-readable medium of claim 14, wherein said design specifications are stored in a database.

18. The computer-readable medium of claim 14, wherein said orthogonal constraint sets are independently created for each tool in said design flow in a context of flow steps.

19. The computer-readable medium of claim 14, wherein said orthogonal constraint sets are created throughout said design flow, said design flow being an end to end flow.

20. The computer-readable medium of claim 14, wherein said applying step comprises generating at least one of synthesis constraints, modal STA constraints, checking constraints, test mode constraints, detailed physical optimization constraints, detailed STA constraints, or sign off STA constraints.
